(19) United States
(12) Patent Application Publication
(10) Pub. No.: US 2010/0097815 A1
(43) Pub. Date: Apr. 22, 2010

(54) LAMP WITH ANGLE ADJUSTING MEMBER

(75) Inventors: GUANG SONG, Shenzhen City (CN); LI HE, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/417,649

(22) Filed: Apr. 3, 2009

(30) Foreign Application Priority Data
Oct. 21, 2008 (CN) 200810305078.9

(51) Int. Cl. F21V 19/02

(52) U.S. Cl. 362/418

(57) ABSTRACT

A lamp includes a lamp pole, a lamp head and a locating slide. The lamp pole includes a connector. The lamp head includes a lamp body and a catch sleeve. The connector extends into the catch sleeve. The locating slide is engaged and sandwiched between the connector of the lamp pole and the catch sleeve. The locating slide is movable on the connector along a length direction thereof. A screw extends through the catch sleeve and screws into the locating slide to connect the locating sleeve and the catch sleeve together. When the locating slide together with the screw is moved from a first position to a second position, an elevation angle of the catch sleeve and accordingly the lamp body is varied.

### BACKGROUND

1. Technical Field

The disclosure relates to a lamp and, more particularly, to a lamp whose illuminating angle is adjustable.

2. Description of Related Art

Traditionally, a lamp generally includes a lamp head and a lamp pole supporting the lamp head. Typically, the lamp pole has a certain configuration. The lamp head is immovable relative to the lamp pole when the lamp head is mounted to the lamp pole. Therefore, in use, the lamp pole is held at a certain position, and generally determines a constant elevation angle of the lamp head relative to a place needing illumination. According to the actual requirement, different places may need illumination by the same lamp; thus, an adjustable lamp head which can be moved to aim at different elevation angles is needed.

However, according to the structure of the lamp pole and the lamp head, the elevation angle of the lamp head relative to the places needing illumination is invariable, which cannot meet the requirement of illuminating different places.

What is needed, therefore, is a lamp comprising a lamp head whose orientation is adjustable in respect to the lamp pole, thereby overcoming the described limitations.

### BRIEF DESCRIPTION OF THE DRAWINGS

Other advantages and novel features of the disclosure will become more apparent from the following detailed description of an embodiment/embodiments when taken in conjunction with the accompanying drawings.

FIG. 1 is an isometric, assembled view of a lamp in accordance with an embodiment of the disclosure.

FIG. 2 is an enlarged, exploded view of a portion of the lamp of FIG. 1.

FIG. 3 is an enlarged, cross sectional view of a portion of the lamp of FIG. 1 in a first position.

FIG. 4 is a view similar to FIG. 3 with the lamp in a second position.

FIG. 5 is an end cross sectional view of the lamp of FIG. 1.

### DETAILED DESCRIPTION

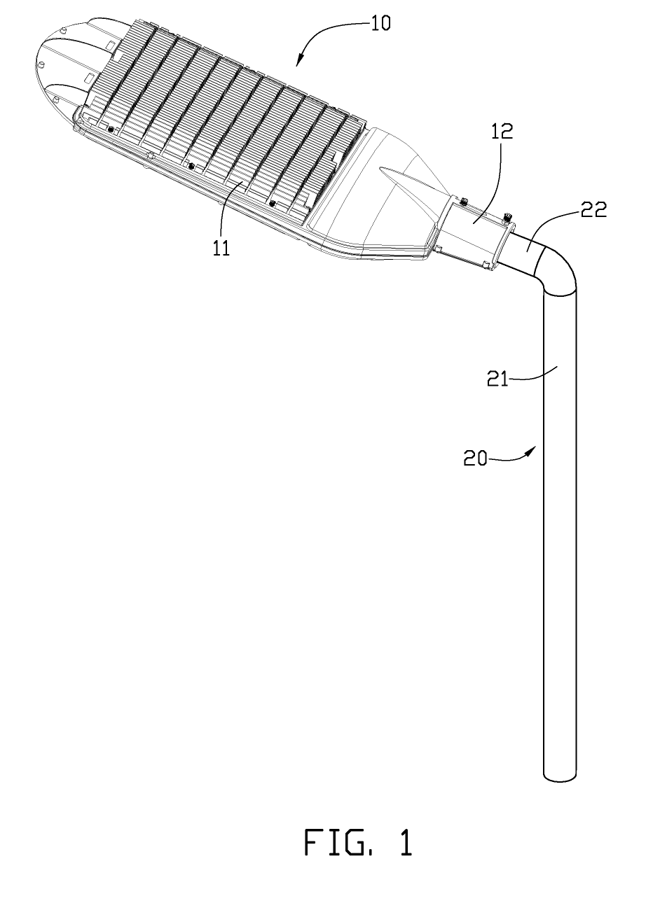

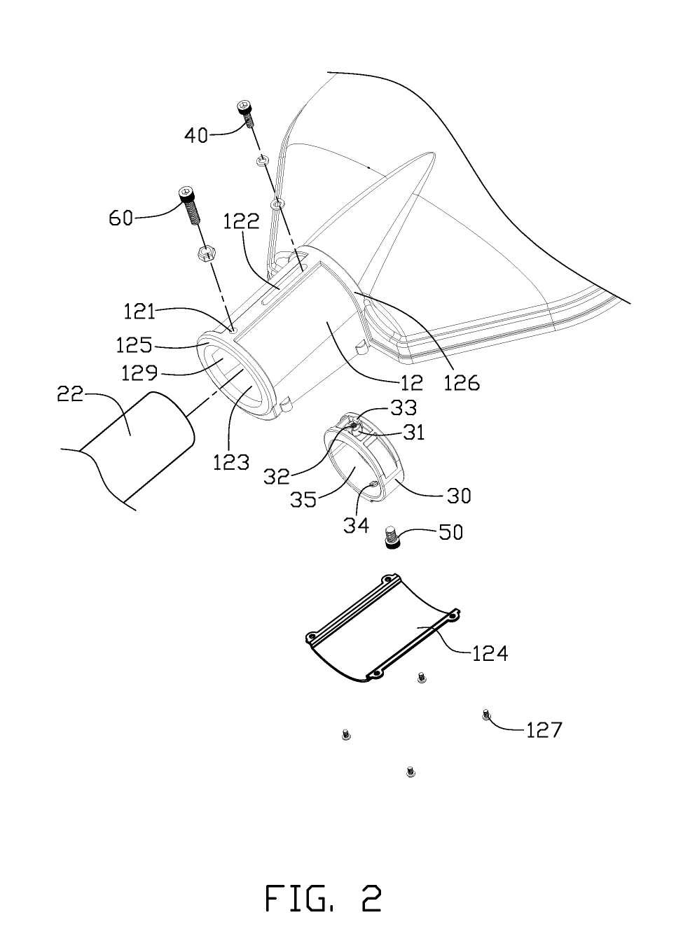

Referring to FIGS. 1-2, a lamp in accordance with an embodiment of the disclosure is shown. In this embodiment, the lamp is an LED lamp used as a street lamp. The lamp comprises a lamp pole 20, a lamp head 10 connecting the lamp pole 20, and a locating slide 30 located between the lamp head 10 and the lamp pole 20. The locating slide 30 is movable along the lamp pole 20 to adjust an angle of the lamp head 10 with respect to the lamp pole 20.

The lamp pole 20 is elongated and cylindrical, and comprises a vertical portion 21 and a connector 22 integrally and slantwise extending upwardly from a top end of the vertical portion 21.

The lamp head 10 comprises a lamp body 11 and a catch sleeve 12 extending rearwards from a rear end of the lamp body 11 and connecting with the connector 22. The lamp body 11 includes a plurality of LED modules (not shown) therein for providing illumination.

The connector 22 is cylindrical and angles with a horizontal direction whereby the lamp head 10 located on the lamp pole 20 defines an acute angle with the horizontal direction to provide an appropriate illumination angle in respect to the horizontal direction. In this embodiment, an included angle of about 105° is defined between the connector 22 and the vertical portion 21, whereby the lamp head 10 angles about 15° relative to the horizontal direction.

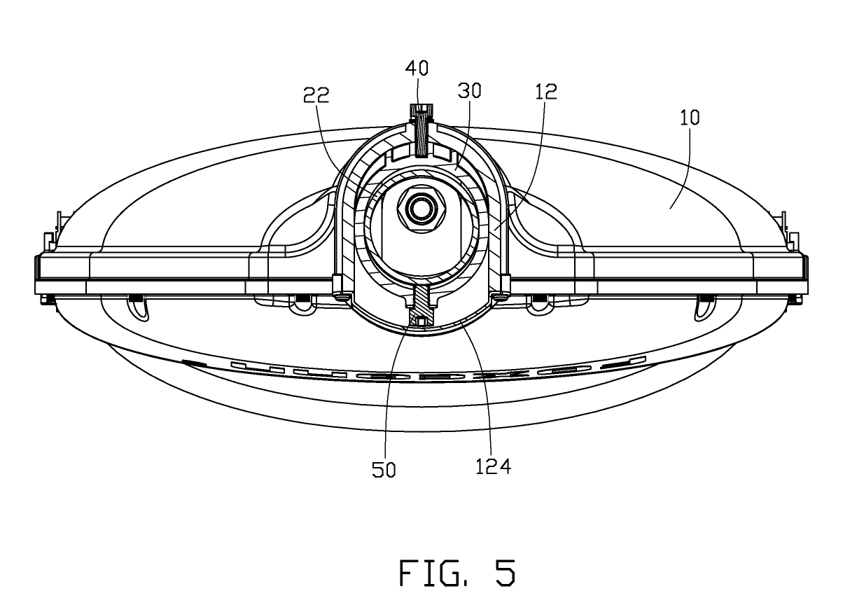

The catch sleeve 12 is tubular and defines a chamber therein (not labeled). The catch sleeve 12 has an arc-shaped cross section with a height longer than a width thereof (best seen in FIG. 5). The catch sleeve 12 defines a screw hole 121 and a slot 122 at a top wall (not labeled) thereof along an axis thereof. The screw hole 121 is located near a rear end 125 of the catch sleeve 12, and the slot 122 is near a front end 126 thereof and spaced from the screw hole 121. The screw hole 121 and the slot 122 both extend through the top wall of the catch sleeve 12. The catch sleeve 12 defines an opening 123 at a bottom thereof, through which the locating slide 30 is received in the chamber defined by the catch sleeve 12. The opening 123 has a width larger than a diameter of the locating slide 30. A bottom cover 124 engages with the bottom of the catch sleeve 12 via a plurality of screws 127 to cover the opening 123 and protect the locating slide 30.

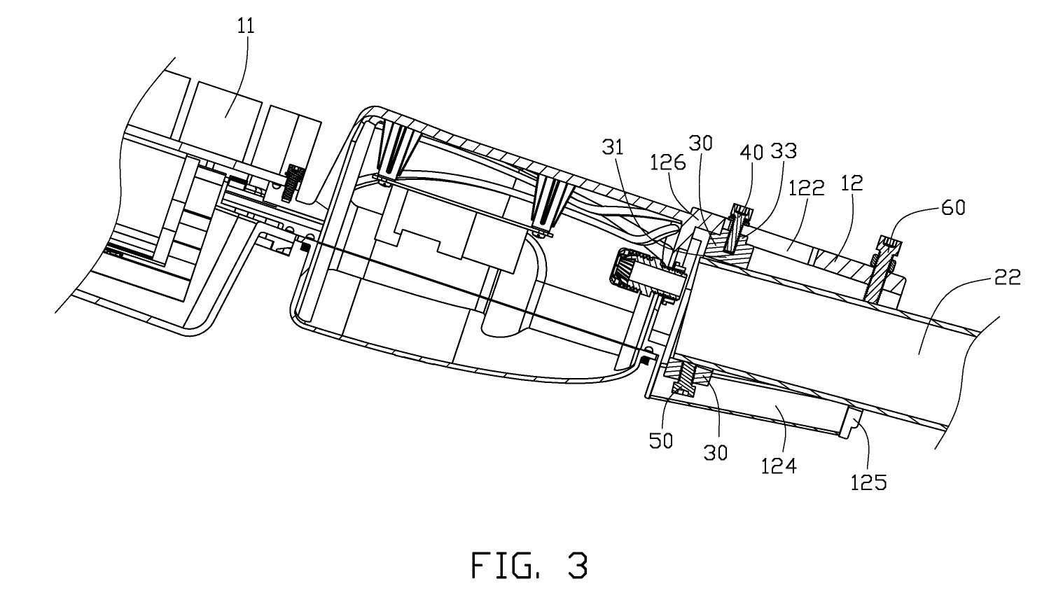

The catch sleeve 12 defines an intake 129 at the rear end 125 thereof. The intake 129 has an inner diameter slightly larger than an outer diameter of the connector 22. The height of the catch sleeve 12, i.e., a distance between the top wall and the bottom cover 124, gradually decreases from the front end 126 toward the rear end 125 of the catch sleeve 12 (best seen in FIG. 3). After the connector 22 of the lamp pole 20 assembled into the catch sleeve 12, a forwardly gradually increased annular gap between the connector 22 and the catch sleeve 12 is defined to permit a swing of a front end of the catch sleeve 12 relative to the connector 22 of the lamp pole 20.

The locating slide 30 is mounted in the catch sleeve 12 and receives the connector 22 therein. The locating slide 30 has an elliptical, ring-like shape and defines a central hole 35 receiving the connector 22 therein. Two lateral inner walls of the locating slide 30 engage lateral portions of an outer surface of the connector 22. The locating slide 30 upwardly extends a supporting portion 31 from an upper portion thereof. The upper portion of the locating slide 30 and the supporting portion 31 are sandwiched between the connector 22 and the top of the catch sleeve 12, whereby the catch sleeve 12 defines the acute angle in respect to the horizontal direction. The supporting portion 31 defines a screw hole 32 corresponding to the slot 122 of the catch sleeve 12. A first position member 40 extends through the slot 122 of the catch sleeve 12 and engages in the screw hole 32 of the supporting portion 31. A pair of protrusions 33 extends upwardly from the supporting portion 31 of the locating slide 30 and is located at front and rear sides of the screw hole 32 of the supporting portion 31, respectively. The protrusions 33 are inserted into the slot 122 of the catch sleeve 12 whereby the locating slide 30 can slide in the catch sleeve 12 along the slot 122. The locating slide 30 defines a radial screw hole 34 through a bottom thereof. A second position member 50 engages in the screw hole 34 and abuts a bottom of the connector 22 to secure the locating slide 30 with the connector 22 of the lamp pole 20. A third position member 60 engages in the screw hole 121 of the catch sleeve 12 and abuts a top of the connector 22 to secure the catch sleeve 12 to the connector 22. In this embodiment, the first, second and the third position members 40, 50, 60 are screws.

Alternatively, the locating slide 30 can be defined in other shape, such as rectangular shape, as long as the locating slide 30 can be secured to the connector 22 of the lamp pole 20 and the catch sleeve 12 when the first and second position members 40, 50 are tighten and be movable along the connector 22 in the catch sleeve 12 when the first and second position members 40, 50 are loosened.

Referring also to FIG. 2, during assembly of the lamp, the locating slide 30 is inserted in the catch sleeve 12 from the opening 123 thereof, with the protrusions 33 of the locating slide 30 extending into the slot 122 of the catch sleeve 12. The catch sleeve 12 and the connector 22 defining a receiving room (not labeled) between the catch sleeve 12 and the connector 22. The receiving room has a gradually varying height. The first position member 40 engages in the screw hole 32. Then, the front end of the connector 22 of the lamp pole 22 is inserted into the catch sleeve 12 to a position received in the locating slide 30. The first position member 40 and the locating slide 30 are moved along the slot 122 of the catch sleeve 12 to an appropriate position. The first position member 40 is operated to secure the catch sleeve 12 tightly with the locating slide 30. The second position member 50 is operated to secure the locating slide 30 tightly to the connector 22 of the lamp pole 20. The third position member 60 is operated to secure the rear end 125 of the catch sleeve 12 tightly to the connector 22. Finally, the bottom cover 124 engages the bottom of the catch sleeve 12 to cover the opening 123 and protect the locating slide 30.

Referring to FIG. 3, the lamp after assembly is in a first position. In this position, the locating slide 30 engages with the connector 22 via the second position member 50. The catch sleeve 12 engages with the locating slide 30 via the first position member 40. The catch sleeve 12 engages with the connector 22 via the third position member 60. The locating slide 30 is sandwiched between the connector 22 and the catch sleeve 12, and located close to the front end 126 of the catch sleeve 12; in other words, the locating slide 30 is located close to the lamp head 10. Simultaneously, the first position member 40 is located at a front end of the slot 122 near to the lamp head 10. The top wall of the catch sleeve 12 is secured intimately to the locating slide 30 via the first position member 40. Thus, the catch sleeve 12 has an angle in respect to the connector 22. Therefore, in use, the lamp head 10 defines a first elevation angle relative to the horizontal direction and is oriented to a first place needing illumination.

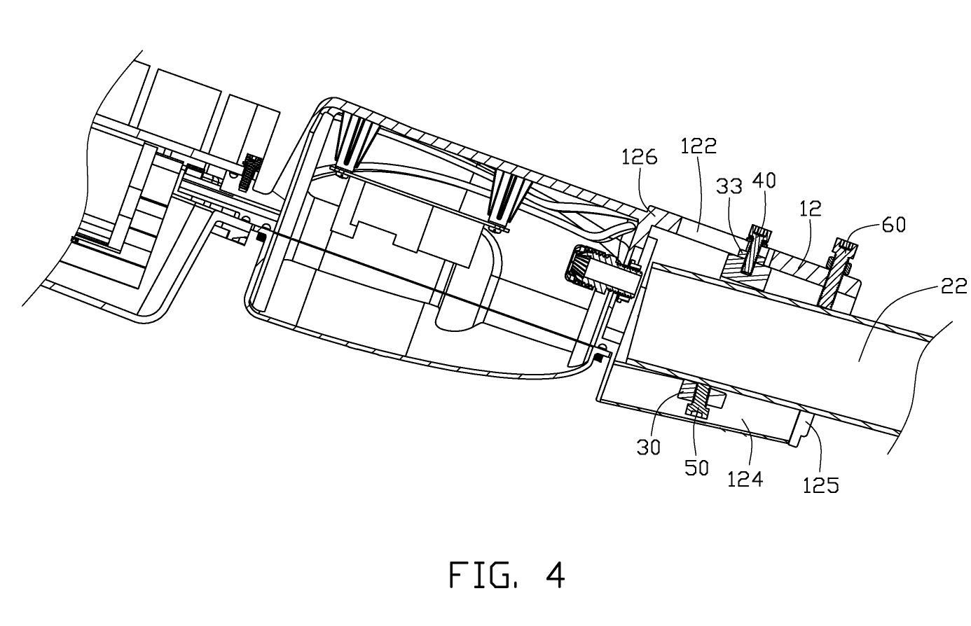

Referring to FIG. 4, the lamp is in a second position. In the second position, the locating slide 30 is pushed to move along the axis of the connector 22 and located close to the rear end 125 of the catch sleeve 12. Simultaneously, the first position member 40 is moved to be located at a rear end of the slot 122 near the rear end 125 of the catch sleeve 12. The second position member 50 is also moved, corresponding to the movements of the first position member 40 and the locating slide 30 and then secured at the rear position. Since the thickness of the locating slide 30 is invariable and the height of the catch sleeve 12 gradually decreases rearwards, movement of the locating slide 30 from the front end 126 to the rear end 125 of the catch sleeve 12 raises the front end 126 of the catch sleeve 12. The lamp head 10 connecting with the front end 126 of the catch sleeve 12 raises upwardly with the front end 126 of the catch sleeve 12 thereby to increase the elevation angle of the catch sleeve 12 and accordingly the elevation angle of the lamp head 10 in respect to the horizontal direction. Therefore, in this second position, the lamp head 10 defines a second elevation angle relative to the horizontal direction and is oriented toward a second place needing illumination; the second elevation angle is larger than the first elevation angle. According to the requirements of different illuminating angles and illumination of different places, the lamp head 10 can be adjusted to a suitable angle in respect to the horizontal direction, with adjustment of a position of the locating slide 30 and the first and second position members 40, 50 to a suitable position between the front and rear ends of the slot 122 of the catch sleeve 12.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lamp comprising:
a lamp pole comprising a connector at a front end thereof;
a lamp head comprising a catch sleeve extending from a rear end of the lamp head, the connector of the lamp pole extending into the catch sleeve of the lamp head, a distance of a gap between the catch sleeve and the connector of the lamp pole is varied along a length direction of the connector; and
a locating slide located between the connector of the lamp pole and the catch sleeve and movable along the connector of the lamp pole and securable to the catch sleeve and the connector of the lamp pole at different positions, respectively, in which the lamp head have different elevation angels, thereby to adjust an elevation angle of the lamp head by moving and securing the locating slide at a selected one of the different positions so that the lamp head can illuminate different places.

2. The lamp as claimed in claim 1, wherein the distance of the gap between the catch sleeve and the connector of the lamp pole is gradually increased from a rear end of the catch sleeve remote from the lamp head to a front end of the catch sleeve near the lamp head.

3. The lamp as claimed in claim 2, wherein the locating slide has an elliptical, ring-shaped configuration and defines a central hole receiving the connector of the lamp pole therein.

4. The lamp as claimed in claim 1, wherein the catch sleeve defines a slot, the lamp further comprising a position member extending through the slot of the catch sleeve and engaging the locating slide with the catch sleeve.

5. The lamp as claimed in claim 4, further comprising a second position member engaging the locating slide with the connector.

6. The lamp as claimed in claim 5, further comprising a third position member engaging the catch sleeve with the connector, the third position member extending through the catch sleeve at a position near the rear end of the catch sleeve.

7. The lamp as claimed in claim 4, wherein the locating slide has an elliptical, ring-shaped configuration and extends upwardly a protrusion engaging in the slot of the catch sleeve.

8. The lamp as claimed in claim 1, wherein the locating slide has an elliptical, ring-shaped configuration and receives the connector of the lamp pole therein.

9. The lamp as claimed in claim 1, wherein the locating slide has two lateral inner walls attaching to lateral sides of an outer surface of the connector.

10. The lamp as claimed in claim 1, wherein the catch sleeve defines an opening through which the locating slide enters the catch sleeve, a bottom cover engaging the catch sleeve to cover the opening.

11. A lamp comprising:
a lamp pole comprising a connector at a front end thereof;
a lamp head comprising a lamp body and a catch sleeve extending from a rear end of the lamp body, the connector extending into the catch sleeve from a rear end of the catch sleeve, the catch sleeve having an arc-shaped end section with a height larger than a width thereof; and
a locating slide received in the catch sleeve and surrounding the connector of the lamp pole, a first screw extending through a top of the catch sleeve to threadedly engage with the locating slide to connect the catch sleeve and the locating sleeve together, the first screw being movable on the catch sleeve along a length direction of the catch sleeve, meanwhile the locating slide being movable on the connector along a length direction thereof, wherein when the first screw together with the locating slide moves from a first position to a second position, an elevation angle of the lamp head is changed to illuminate a different place.

12. The lamp as claimed in claim 11, wherein the locating slide has an elliptical, ring-shaped configuration defining a central hole receiving the connector of the lamp pole therein.

13. The lamp as claimed in claim 11, wherein the catch sleeve defines an elongated slot in the top thereof, the slot having a front end close to a front end of the catch sleeve.

14. The lamp as claimed in claim 11, wherein the lamp is an LED lamp.

15. A lamp comprising:
a lamp pole;
a lamp head;
a connector;
a catch sleeve engaging the connector, the catch sleeve and the connector form an assembly connecting the lamp pole and the lamp head; and
a locating slide located between the connector of the lamp pole and the catch sleeve and movable along the connector to rotate the catch sleeve relative to the connector, thereby to adjust an angle of the lamp head in respect to the lamp pole.

16. The lamp as claimed in claim 15, wherein the catch sleeve is secured on the lamp head, the connector extending from the lamp pole.

17. The lamp as claimed in claim 15, wherein the lamp is an LED lamp.
